(19) United States
(12) Patent Application Publication
(10) Pub. No.: US 2004/0191423 A1
(43) Pub. Date: Sep. 30, 2004

(54) Methods for the deposition of silver and silver oxide films and patterned films

(76) Inventors: Hai Xiong Ruan, Burnaby (CA); Juan Pablo Bravo-Vasquez, Ithaca, NY (US); Ross Henry Hill, Coquitlam (CA)

Correspondence Address: MORGAN, LEWIS & BOCKIUS, LLP., 2 PALO ALTO SQUARE, PALO ALTO, CA, 94306, US

(21) Appl. No.: 10/716,838

(22) Filed: Nov. 18, 2003

Related U.S. Application Data
(63) Continuation-in-part of application No. 10/263,701, filed on Oct. 4, 2002.
Application No. 10/263,701 is a continuation-in-part of application No. 09/561,744, filed on Apr. 28, 2000, now Pat. No. 6,348,239.

(51) Int. Cl. B05D 3/06

(52) U.S. Cl. 427/554; 427/558

(57) ABSTRACT

A photoresist-free method for depositing films composed of metal and metal oxide from metal complexes. More specifically, the method involves the deposition of silver and silver oxide films by applying the amorphous film of a silver complex to a substrate. The silver complexes have the formula AgₐL_{c}, wherein L is preferentially a ligand selected from the group consisting of acac, carboxylato, alkoxy, azide, carbonyl, nitrato, amine, halide, nitro, and mixtures thereof, and a and c are greater than one. These films, upon, for example, thermal, photochemical or electron beam irradiation may be converted to the metal or its oxides. By using either directed light or electron beams, this may lead to a patterned metal or metal oxide film in a single step.

This application is a continuation-in-part of U.S. application Ser. No. 10/263,701, filed Oct. 4, 2002, which was a continuation-in-part of U.S. application Ser. No. 09/561,744, filed Apr. 28, 2000, now U.S. Pat. No. 6,348,239, the disclosures of both of which are incorporated herein by reference in their entirety, and also claims the benefit of U.S. Provisional Application No. 60/327,090, filed Oct. 5, 2001, the disclosure of which is incorporated herein by reference in its entirety.

### BACKGROUND OF THE INVENTION

1. Field of the Invention

This invention relates to the use of metal oxide precursor materials to deposit films of metals or metal oxides. More particularly, the methods of the present invention relate to the deposition of silver and silver oxide films and patterned films.

2. Description of the Related Art

Metals such as silver may be used as conductors in electronic circuits. Metal oxides, such as silver oxide, are semiconductors and have found use as conductors in electronic circuitry. Accordingly, there is much interest in the development of methods of achieving the deposition of silver and the patterned deposition of silver and silver oxide on various substrates.

The semiconductor and packaging industries, among others, utilize conventional processes to form thin metal and metal oxide films, including silver and silver oxide films, in their products. Examples of such processes include evaporation, sputter deposition or sputtering, chemical vapor deposition (“CVD”) and thermal oxidation.

Evaporation is a process whereby a material to be deposited is heated near the substrate on which deposition is desired. Normally conducted under vacuum conditions, the material to be deposited volatilizes and subsequently condenses on the substrate, resulting in a blanket or unpatterned film on the substrate. This method has several disadvantages, including, for example, the requirement of heating the desired film material to high temperatures and the need for high vacuum conditions.

Sputtering is a technique similar to evaporation in which the process of transferring the material for deposition into the vapor phase is assisted by bombarding that material with incident atoms of sufficient kinetic energy such that particles of the material are dislodged into the vapor phase and subsequently condense onto the substrate. Sputtering suffers from the same disadvantages as evaporation and, additionally, requires Sputtering suffers from the same disadvantages as evaporation and, additionally, requires equipment and consumables capable of generating incident particles of sufficient kinetic energy to dislodge particles of the deposition material.

CVD is similar to evaporation and sputtering but further requires that the particles being deposited onto the substrate undergo a chemical reaction during the deposition process in order to form a film on the substrate. While the requirement for a chemical reaction distinguishes CVD from evaporation and sputtering, the CVD method still demands the use of sophisticated equipment and extreme conditions of temperature and pressure during film deposition.

In thermal oxidation a blanket layer of an oxidized film on a substrate is produced by oxidizing an unoxidized layer that had previously been deposited on the substrate. However, thermal oxidation generally employs extreme temperature conditions and an oxygen atmosphere.

Several existing film deposition methods may begin under conditions of ambient temperature and pressure, including sol-gel and other spin-on methods, but these methods do not fully eliminate the need for heating. In these methods, a solution containing precursor particles that may be subsequently converted to the desired film composition is applied to the substrate. Application of this solution may be accomplished through spin-coating or spin-casting, where the substrate is rotated around an axis while the solution is dropped onto the middle of the substrate. However, following ambient temperature application, the coated substrate must still be subjected to high temperatures to convert the precursor film into a film of the desired material. Thus, these methods do not allow for direct imaging at ambient temperature to form patterns of the amorphous film. Instead, they result in blanket, unpatterned films of the desired material and still require the application of extreme temperatures to effect conversion of the deposited film to the desired material.

Furthermore, once film deposition is accomplished via one of these deposition methods, a separate patterning step is necessary if a patterned film is required. In one method of patterning blanket films, the blanket film is coated (either by spin coating or other solution-based coating method, or by application of a photosensitive dry film) with a photosensitive coating. This photosensitive layer is selectively exposed to light of a specific wavelength through a mask. The exposure changes the solubility of the exposed areas of the photosensitive layer in such a manner that either the exposed or unexposed areas may be selectively removed by use of a developing solution. The remaining material is then used as a pattern transfer medium, or mask, for an etching medium that patterns the film of the desired material. Following this etch step, the remaining (formerly photosensitive) material is removed, and any by-products generated during the etching process are cleaned away if necessary.

In another method of forming patterned films on a substrate, a photosensitive material may be patterned as described above. Following patterning, a conformal blanket of the desired material may be deposited on top of the patterned (formerly photosensitive) material. The substrate with the patterned material and the blanket film of the desired material is then exposed to a treatment that attacks the formerly photosensitive material. This treatment removes the remaining formerly photosensitive material and with it portions of the blanket film of desired material on top. In this fashion a patterned film of the desired material results; no etching step is necessary in this “liftoff” process. However, the use of an intermediate pattern transfer medium (photosensitive material) is still required, which is a disadvantage. It is also known that the “liftoff” method has severe limitations with regard to the resolution (minimum size) that may be achieved by the pattern of the desired material. This limitation severely restricts the usefulness of this method.

In yet another method of forming patterned films, a blanket film of desired material may be deposited by, for example, one of the methods described above, onto a substrate that has previously been patterned by, for example, an etching process. The blanket film is deposited in such a way that its thickness fills in and completely covers the existing pattern in the substrate. A portion of the blanket film is then isotropically removed until the remaining desired material and the top of the previously patterned substrate are at the same height. Thus, the desired material exists in a pattern embedded in the previously patterned substrate. The isotropic removal of the desired material may be accomplished via etching or through a process known as chemical mechanical planarization (“CMP”), which involves the use of a slurry of particles in conjunction with a chemical agent to remove substantial quantities of the desired material through a combination of chemical and mechanical action, leaving behind the desired material embedded in the patterned substrate. This method of forming a patterned film demands the use of expensive and complicated planarization equipment and extra consumable materials including planarization pads, slurries and chemical agents. In addition, the use of small slurry particles demands that these particles be subsequently removed from the planarized surface, invoking extra processing steps.

These conventional processes for forming metal and metal oxide films are not optimal because, for example, they each require costly equipment, are time consuming, require the use of high temperatures to achieve the desired result, and result in blanket, unpattemed films, where, if patterning is needed, further patterning steps are required. Many of these methods suffer the additional disadvantage of, in many cases, forming polycrystalline films, which may not be suitable for a variety of applications. Accordingly, there is a need for a method of making a patterned film in fewer processing steps that are less time consuming and that require less costly equipment. In particular, there is a need for a method for making a patterned films that comprise silver and silver oxide materials.

### SUMMARY OF THE INVENTION

The present invention provides a process for making a patterned film of desired materials. In one embodiment of the present invention, a silver or silver oxide film is deposited on a substrate by selecting at least one silver-containing precursor material, forming a layer comprising the precursor material on a substrate, and irradiating the layer, thereby forming a silver and silver oxide film on the substrate. No high-temperature heating step is necessary, thus eliminating a time-consuming and high cost process step.

The processes of the present invention are useful in the deposition of films containing silver and silver oxide materials. These processes are advantageous over prior art deposition methods because they avoid the expense and time associated with the additional processing steps required in the prior art, such as masking, exposure and removal, CMP removal of excess material, and high temperature processing. The present invention has the additional benefit of eliminating the need to store additional chemical reagents necessary to accomplish the prior art methods, thus improving cleanroom storage and decreasing the possibility of contamination. Yet another benefit of the current invention is that it eliminates the need for photoresist in patterning electronic materials. This reduces the likelihood of device contamination from removal of the organic photoresist material in subsequent processing steps following patterning. The present invention allows for advantages unavailable with other film deposition and formation methods. As a result, it presents the user with a greater ability to control and manipulate the characteristics of the resulting film to suit the desired application. Such films may be of use in a variety of applications, including, but not limited to, microelectronic fabrication. Therefore, the present process is useful in a broad spectrum of applications.

### BRIEF DESCRIPTION OF THE DRAWINGS

FIG. 1 is a process flow diagram according to an embodiment of the present invention;

FIG. 2A is a schematic cross-sectional view of a substrate covered with precursor material being exposed to an energy source that will convert the precursor material;

FIG. 2B is a schematic cross-sectional view of a substrate covered with converted precursor material following exposure to an energy source, with subsequent development of the unexposed precursor material;

FIG. 2C is a schematic cross-sectional view of a substrate covered with precursor material being exposed to an energy source with a steering mechanism that will form a patterned converted precursor material without using a photomask;

FIG. 2D is a schematic cross-sectional view of a substrate covered with precursor material receiving a blanket exposure from an energy source that will convert the precursor material;

FIG. 3 illustrates deposition of a pattered film through a process according to one embodiment of the present invention;

FIG. 4 is a series of Fourier Transform Infrared spectra showing the extent of reaction of a silver (I) trifluoroacetylacetonate film with exposure to 254 nm light;

FIG. 5 shows an x-ray diffraction pattern of a silver film produced using an embodiment of the present invention; and

FIG. 6 illustrates negative lithographic deposition of silver using an embodiment of the present invention.

### DETAILED DESCRIPTION OF THE INVENTION

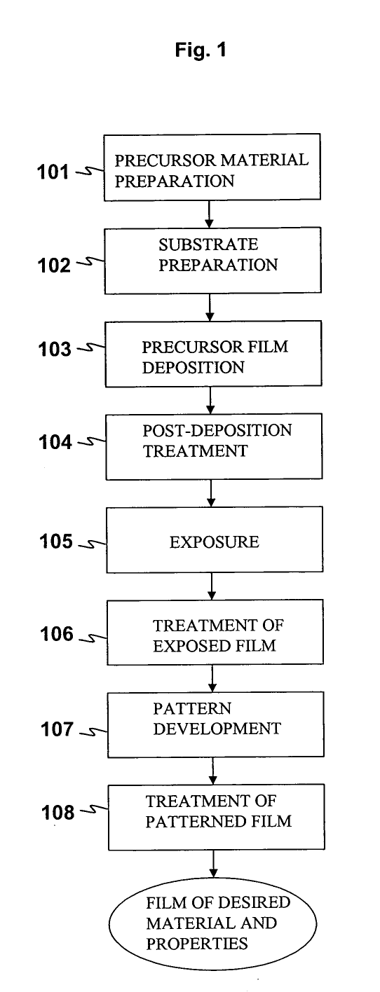

FIG. 1 is a process flow diagram according to an embodiment of the present invention. FIG. 1 provides an overview of one embodiment of a process that may be followed to obtain a film of a desired material with optimized properties for a particular application. Many of these steps are fully optional based on the ultimate application of the film. The present invention is also not limited to these steps and may include other steps based on the ultimate application of the film. One skilled in the art will know which steps should be included or excluded to achieve the desired result for the particular application. Additionally, at each step, variables exist that may be manipulated to affect the resulting film. Again, one skilled in the art will know which variable should be manipulated, and in what way, to effect the desired film properties.

Step 101 of FIG. 1 involves the choice and preparation of a precursor material. The precursor material may be a single chemical species, or a mixture of different chemical species, depending on the final film composition. The present invention will typically be drawn toward the formation of silver or silver oxide patterned films. However, it is recognized that the formation of films containing a mixture of silver and/or silver oxide with other metallic or semi-metallic species may be desirable in some embodiments, and nothing in this document should be read to preclude the formation of such films. If such a mixed-metal film is desired, a variety of chemical species containing different metallic or semi-metallic elements in the complex will be necessary to form the desired precursor material. Furthermore, it is important to recognize that the choice of chemical species that make up the precursor material is subject to additional processing constraints associated with the present invention. In particular, the precursor material further comprises molecules specifically designed for their ability to coat the substrate in a uniform manner, resulting in films of high optical quality that possess, in the case of the present process, photosensitive properties. As discussed further below, such properties in deposited films are most often associated with the ligand portion of the complex comprising the precursor material.

A wide variety of metal complexes of the formula MₐL_{c} comprising at least one metal (“M”), where a is an integer that is at least 1, and at least one suitable ligand (“L”) or ligands, where c is an integer that is at least 1, are envisioned by this invention. More precisely, when Mₐ is a single metal species (i.e. a equals 1), M must be Ag. However, in certain embodiments it may be desirable to deposit an additional metal species, along with silver, to modify the electrical or physical properties of the final film, for instance. If a plurality of metals is used, all of the metal atoms may be identical, all may be different atoms and/or have different valences, e.g., BaNa or Fe(II) Fe(III), or some may be identical while others may be different atoms and/or have different valences, e.g., Ba₂ Fe(II) Fe(III). In any case, the additional metal M may be an alkali or alkaline earth, for example Ba or Li, a transition metal, for example Cr or Ni, a main group metal, for example Al or Sn, or an actinide, for example U or Th. Preferably, the additional metal M is independently selected from Li, Al, Si, Ti, V, Cr, Mn, Fe, Ni, Co, Cu, Zn, Sr, Y, Zr, Nb, Mo, Ru, Rh, Pd, In, Sn, Ba, La, Pr, Sm, Eu, Hf, Ta, W, Re, Os, Ir, Pt, Au, Pb, Th, U, Sb, As, Ce, and Mg.

Similarly, there is a wide variety of ligands that may be used for the present invention. However, the choice of ligand is important because it influences the nature of both the precursor molecule and the final deposited film. Ligand L is preferably chosen so that the precursor material has the following properties: (1) it can be deposited in an amorphous film on a substrate, and will remain amorphous until a subsequent processing step; (2) the amorphous film is stable, or at least metastable; (3) upon absorbing energy, for example, a photon of the required energy, the film can be transformed into a different metal-containing material through a chemical reaction; and (4) any byproducts of the energy-induced chemical reaction should be removable, e.g., should be sufficiently volatile so as to be removable from the film. In addition, for certain embodiments of the present invention it may be necessary to use a mixture of ligands. If a plurality of ligands is used, all of the ligands may be identical, all may be different, or some may be identical while others may be different.

The amorphous quality of the film is desirable for at least two reasons. The deposited film of precursor material should be amorphous or at least substantially amorphous to ensure that the film will have the desired isotropic optical properties. Additionally, an amorphous film provides the additional advantage of minimizing recombination reactions, which occur in a more crystalline environment. Avoiding such reactions leads to a higher quantum yield for photoreactions within the film. To form an amorphous film, the complex should generally possess a low polarity and low intermolecular forces. As organic groups usually have low intermolecular forces, ligands having organic groups at their outer peripheries typically are satisfactory. Furthermore, to make the metal complex resistant to crystallization, ligand(s) L preferably are such that the complex is of lower symmetry, which can, in certain embodiments, slow the crystallization rate. Alternatively, one may use unresolved chiral ligands in the metal complex to slow crystallization. For example, if L is racemic 2-ethylhexanoate, the resulting metal precursor is a mixture of metal complexes which differ in their three-dimensional structure, often existing as enantiomers, diastereomers, or a mixture of both. The size and shapes of organic portions of the ligands may be selected to optimize film stability and to adjust the thickness of film that will be deposited by the selected film deposition process.

The tendency of an amorphous film to remain amorphous may also be enhanced by forming the film from a complex that has several different ligands attached to each metal atom. Such metal complexes have several isomeric forms. For example, the reaction of CH₃HNCH₂CH₂NHCH₃ with a mixture of a nickel(II) salt and KNCS leads to the production of a mixture of isomers. The chemical properties of the different isomers are known not to differ significantly; however, the presence of several isomers in the film impairs crystallization of the complex in the film.

Further on the subject of amorphous films, it is important to recognize that amorphous films are distinct from polycrystalline and crystalline films. In addition, different amorphous films formed by different film-forming methods may be different from one another. Through judicious choice of process parameters, the different properties of different amorphous films formed by different methods can be controlled and engender specific chemical, physical and mechanical properties that are useful in particular applications, for example, as a layer(s) in a semiconductor device and/or in their fabrication.

Another requirement of the precursor material is the complex must also be stable, or at least metastable, in that it will not rapidly and spontaneously decompose under process conditions. The stability of complexes of a given metal may depend, for example, upon the oxidation state of the metal in the complex. For instance, Ni(0) complexes are known generally to be unstable in air while Ni(II) complexes are often air-stable. Consequently, a process for depositing Ni-based films which includes processing steps in an air atmosphere should include a Ni(II) complex in preference to a Ni(0) complex.

As discussed below, partial conversion and conversion result from a chemical reaction within the film that changes substantially unconverted or partially converted regions into a desired converted material. Ideally, at least one ligand should be reactive and be attached to the complex by a bond that is cleaved when the complex is raised to an excited state by the influence of the energy applied to convert the precursor material. If the energy applied is light energy, the chemical reaction of step (3) is known as a photochemical reaction. Photochemical reactions initiated by light energy, or more preferably by ultraviolet light, are the most preferred form of applied energy. To make such photochemical step(s) in the process efficient, it is highly preferable that the intermediate product produced when the reactive group is severed be unstable and spontaneously convert to the desired new material and volatile byproduct(s).

Exemplary metal complexes, and their metal and ligand components, are described in U.S. Pat. No. 5,534,312, “Methods for Directly Depositing Metal Containing Patterned Films” to Hill, et. al., which is incorporated herein by reference in its entirety. Preferred metal complex precursors include ligands that meet the above criteria. More preferably, the ligands are selected from the group consisting of acetylacetone (also known as “acac” or 2,4-pentanedione) and its anions; substituted acetylacetone,

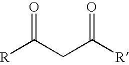

and its anions; acetonylacetone (also known as 2,5-hexanedione) and its anions; substituted acetonylacetone,

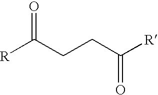

and its anions; dialkyldithiocarbamates,

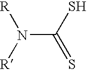

and its anions; carboxylic acids,

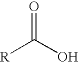

such as hexanoic acid where R═CH₃(CH₂)₄; carboxylates,

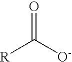

such as hexanoate where R═CH₃(CH₂)₄; pyridine and/or substituted pyridines,

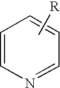

azide, i.e., N₃⁻; amines, e.g., RNH₂; diamines, e.g., H₂NRNH₂; arsines,

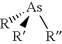

diarsines,

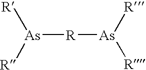

phosphines,

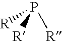

diphosphines,

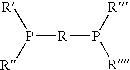

arenes,

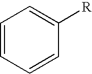

hydroxy, i.e., OH⁻; alkoxy ligands, e.g., RO⁻; ligands such as (C₂H₅)₂NCH₂CH₂O—; alkyl ligands, e.g., R⁻; and aryl ligands, and mixtures thereof, where each R, R′, R″, R′″, and R″″ is independently selected from organic groups and, preferably, is independently selected from alkyl, alkenyl, aralkyl and aralkenyl groups.

As used herein, the term “alkyl” refers to a straight or branched hydrocarbon chain. As used herein, the phrase straight chain or branched chain hydrocarbon chain means any substituted or unsubstituted acyclic carbon-containing compounds, including alkanes, alkenes and alkynes. Examples of alkyl groups include lower alkyl, for example, methyl, ethyl, n-propyl, iso-propyl, n-butyl, iso-butyl, tert-butyl or iso-hexyl; upper alkyl, for example, n-heptyl, -octyl, iso-octyl, nonyl, decyl, and the like; lower alkylene, for example, ethylene, propylene, propylyne, butylene, butadiene, pentene, n-hexene or iso-hexene; and upper alkylene, for example, n-heptene, n-octene, iso-octene, nonene, decene and the like. The ordinary skilled artisan is familiar with numerous straight, i.e., linear, and branched alkyl groups, which are within the scope of the present invention. In addition, such alkyl groups may also contain various substituents in which one or more hydrogen atoms is replaced by a functional group or an in-chain functional group.

As used herein, the term “alkenyl” refers to a straight or branched hydrocarbon chain where at least one of the carbon-carbon linkages is a carbon-carbon double bond. As used herein, the term “aralkyl” refers to an alkyl group which is terminally substituted with at least one aryl group, e.g., benzyl. As used herein, the term “aralkenyl” refers to an alkenyl group which is terminally substituted with at least one aryl group. As used herein, the term “aryl” refers to a hydrocarbon ring bearing a system of conjugated double bonds, often comprising at least six π (pi) electrons. Examples of aryl groups include, but are not limited to, phenyl, naphthyl, anisyl, toluyl, xylenyl and the like.

The term “functional group” in the context of the present invention broadly refers to a moiety possessing in-chain, pendant and/or terminal functionality, as understood by those persons of ordinary skill in the relevant art. Examples of in-chain functional groups include, for example, ethers, esters, amides, urethanes and their thio-derivatives, i.e., where at least one oxygen atom is replaced by a sulfur atom. Examples of pendant and/or terminal functional groups include, for example, halogens, such as fluorine and chlorine, and hydrogen-containing groups such as hydroxyl, amino, carboxyl, thio and amido, isocyanato, cyano, epoxy, and ethylenically unsaturated groups such as allyl, acryloyl and methacryloyl, and maleate and maleimido.

To enhance the desired photochemical characteristics, including the tendency of the products of the photochemical reaction to spontaneously thermally decompose, ligands comprising and/or selected from one or more of the following groups may be used alone or in combination with the above-listed ligands: oxo, O₂⁻, oxalato,

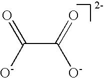

halide; hydrogen; hydride, i.e., H—; dihydride, i.e., H₂; hydroxy; cyano, i.e., CN—; carbonyl; nitro, i.e., NO₂; nitrito, i.e., NO₂—; nitrate, i.e, NO₃ ²⁻; nitrato, i.e., NO₃—; nitrosyl, i.e., NO; ethylene; acetylenes,

R≡R′

thiocyanato, i.e., SCN⁻; isothiocyanato, i.e., NCS⁻; aquo, i.e., H₂O; azides; carbonato, i.e., CO₃⁻²; amine; and thiocarbonyl, where each R and R′ is independently selected from organic groups and, preferably, is independently selected from alkyl, alkenyl, aralkyl and aralkenyl groups. Even more preferably, each ligand is independently selected from acac, carboxylates, alkoxy, oxalato, azide, carbonyl, nitro, nitrato, amine, halogen and their anions.

It should be appreciated that the choice of precursor material may have a significant influence on the properties of the desired film that is not readily predictable. For example, two precursors ML and ML′, each consisting of metal M and one of two different ligands L or L′, might be expected to form films of the desired material which are identical because, for example, the portions of the ligands which differ from each other would be removed during conversion of the precursor into a metal film. In fact, the supposedly identical film products of these two similar reactants may differ significantly in their properties. Examples of properties which may be affected in this process include the dielectric constant and the presence/absence of any secondary or tertiary structure in the film. Possible reasons for this difference may relate to the rate of formation of the amorphous material and the ability of the photo-ejected ligand to remove energy from the photo-produced film of desired material. The presence of ligand fragments during an exposure process may also affect the film forming process, influencing such phenomena as diffusion properties of the film, nucleation, and crystal growth.

Further, the choice of the precursor material in film formation and photochemical exposure can substantially influence further reactivity of the film of the desired material with, for example, gaseous constituents of the atmosphere in which the desired film is formed. This could influence, for example, the rate of oxidation of the deposited film where either a high or low rate could be an advantage depending upon the desired product. Additionally, it is recognized that the effect of the precursor material upon the healing ability of the film, i.e., its ability to minimize crazing, and the shrinkage or densification of the film may be substantially influenced by the choice of precursors that would otherwise be seen to yield identical results by one skilled in the art.

In step 102 of FIG. 1, which is fully optional, a substrate is prepared for deposition of the precursor film. The nature of the substrate to which the precursor is applied is not critical for the process although it may affect the method of deposition of the precursor film and the solvent for the deposition, if one is used. Substrates may include, but are not limited to, simple salts, such as CaF₂, semiconductor surfaces, including silicon, compound semiconductors, including silicon germanium and III-V and II-VI semiconductors, printed and/or laminated circuit board substrates, metals, ceramics, and glasses. Silicon wafers, ceramic substrates and printed circuit boards have been used extensively. Prior to its use in the present process, other types of substrate preparation known in the art may be performed, such as cleaning the substrate, the deposition of an adhesion promoter, and/or the use of a reactive layer. In addition, the substrate may be coated with single or multiple layers, such as dielectric layers, photoresist, polyimide, metal oxides, thermal oxides, conductive materials, insulating materials, ferroelectric materials or other materials used in the construction of electronic devices. If no substrate preparation is required prior to deposition, processing should continue directly from step 101 to step 103.

In step 103 of FIG. 1, the precursor film is deposited. The method of application of the precursor or the precursor solution may be chosen depending on the substrate and the intended application. Note that discussion applies to both precursor and precursor solution although only discussed in terms of precursor. Some examples of useful coating methods well known to those of skill in the art include spin, spray, dip and roller coating, stamping, meniscus, and various inking approaches, e.g., inkjet-type approaches. Variables in the coating process may be chosen to control the thickness and uniformity of the deposited film, to minimize edge effects and the formation of voids or pinholes in the film, and to ensure that no more than the required volume of precursor or precursor solution is consumed during the coating process. Optimized application of the precursor film may desirably yield very smooth films.

The precursor material may be applied to the substrate alone or preferably as a precursor solution comprising the precursor material dissolved in a solvent or solvents. The use of a solvent facilitates the application of the precursor material to the substrate by a variety of means known to those of ordinary skill in the art, such as by spin or spray application of the solution to the substrate. The solvent may be chosen based on several criteria, individually or in combination, including the ability of the solvent to dissolve the precursor, the inertness of the solvent relative to the precursor, the viscosity of the solvent, the solubility of oxygen or other ambient or other gases in the solvent, the UV, visible, and/or infra-red absorption spectra of the solvent, the absorption cross-section of the solvent with respect to electron and/or ion beams, the volatility of the solvent, the ability of the solvent to diffuse through a subsequently formed film, the purity of the solvent with respect to the presence of different solvent isomers, the purity of the solvent with respect to the presence of metal ions, the thermal stability of the solvent, the ability of the solvent to influence defect or nucleation sites in a subsequently formed film, and environmental considerations concerning the solvent. Exemplary solvents include the alkanes, such as hexanes, the ketones, such as methyl isobutyl ketone (“MIBK”) and methyl ethyl ketone (“MEK”), and propylene glycol monomethyl ether acetate (“PGMEA”).

The concentration of the precursor in the solution may be varied over a wide range and may be chosen by one of ordinary skill in the art with, at most, minimal routine experimentation, such that the properties of the precursor film, including its thickness and/or sensitivity to irradiation by light or particle beams, are appropriate for the desired application.

Finally, chemical additives are optionally used with the precursor material, if applied alone, or in the precursor solution. These may be present for any or several of the following reasons: to control the photosensitivity of a subsequently deposited precursor or film, to aid in the ability to deposit uniform, defect-free films onto a substrate, to modify the viscosity of the solution, to enhance the rate of film formation, to aid in preventing film cracking during subsequent exposure of the deposited film, to modify other bulk properties of the solution, and to modify in important ways the properties of the film of the desired material. The additives are chosen according to these criteria in addition to those criteria employed when choosing a suitable solvent. It is preferable that the precursor or the precursor solution be substantially free of particulate contamination so as to enhance its film-forming properties.

In some embodiments, no further processing of the precursor material is required. More often, however, processing will continue with either post-deposition treatment 104 or proceed directly to the exposure stage 105.

In step 104 of FIG. 1, following deposition, an optional post-deposition treatment may be used. The deposited film may, for instance, optionally be subjected to a baking or vacuum step where any residual solvent present in the deposited film may be driven off. If such a baking step is employed, it is, of course, important to use the minimum amount of heat necessary to drive off the solvent. Application of excessive heat to the precursor material may cause the film to decompose through thermal decomposition.

It is recognized, however, that a higher temperature bake step at this stage of the process may be advantageous. Employing a higher-temperature bake will contribute not only to ejecting solvent from the precursor film, as described above, but a suitably high temperature may also initiate a thermal decomposition process. Both of these mechanisms may aid in the overall efficiency of the process resulting in, for example, a lower dose requirement during a subsequent partial converting and/or converting step. It is further recognized that during such a bake step, a new material, different from either the deposited film or the film of the desired material, may be formed. The effect of this could significantly alter subsequent properties of the desired material, including dielectric constant, nucleation, speciation, and crystallization behavior in ways that are not readily predicted by one skilled in the art. For example, a two component system in which one precursor material is activated in the pre-bake step while the other precursor(s) is selected to be activated in either a photochemical or higher energy thermal process step may be preferred in certain applications. This deposition, from a mixture of precursors, would permit the efficient design of a system to take advantage of the different chemical properties of materials formed from the bake and subsequent partial converting and/or converting step(s). The use of such a partial conversion step, or different conversion steps in sequence, also known as “substrate pretreatment,” may be advantageous from a process flow standpoint, for example, in order to minimize the time during which a precursor on a substrate needs to be exposed in an expensive piece of equipment, such as a stepper. Substrate pretreatment is described in U.S. patent application Ser. No. 09/874,330 to Lee, et. al., which is incorporated by reference in its entirety herein.

Alternatively, in using silver precursors, for example, heating may be used as the sole source of film formation. The film is first deposited using one of the techniques disclosed previously. The film is next heated to 35 C for 160 seconds, for example. This causes the precursor film to decompose. The resulting metal layer is a mixture of silver and silver oxide, and is a blanket film. This film could then act as, for example, a barrier layer, and serve as a substrate for other subsequently deposited films. Alternatively, the film could be patterned using prior art techniques (not shown).

Finally, the deposited film may optionally be subjected to other treatments at this stage of the process including, but not limited to, blanket photochemical or electron beam exposure and microwave treatment. For instance, by varying the intensity of light exposure, e.g., increasing it, it is possible to initiate thermal reaction within the films to generate product films through photoinduced reaction.

In step 105 of FIG. 1, the deposited film is next subjected to an energy source such that the precursor is at least partially converted though photolytic conversion. The entire film, or selected regions of the deposited precursor film, may be exposed to a source of energy. The energy source may be, e.g., a light source of a specific wavelength, a coherent light source of a specific wavelength or wavelengths, a broadband light source, an electron beam (“e-beam”) source, or an ion beam source. Light in the wavelength range of from about 150 to about 600 nm may be used.

Without being bound by any particular theory, it is believed that there are several mechanisms by which a suitable photochemical reaction may occur to cause conversion of the precursor material. Some examples of suitable reaction mechanisms which may be operable, individually or in combination, according to the invention are as follows: (a) absorption of a photon that places the complex in a ligand to metal charge transfer excited state in which a metal-to-ligand bond in the metal complex is unstable; the bond breaks, and the remaining parts of the complex spontaneously decompose; (b) absorption of a photon that places the complex in a metal-to-ligand charge transfer excited state in which a metal-to-ligand bond in the complex is unstable; the bond breaks, and the remaining parts of the complex spontaneously decompose; (c) absorption of a photon that places the complex in a d-d excited state in which a metal-to-ligand bond in the complex is unstable; the bond breaks, and the remaining parts of the complex spontaneously decompose; (d) absorption of a photon that places the complex in an intramolecular charge transfer excited state in which a metal-to-ligand bond in the complex is unstable; the bond breaks, and the remaining parts of the complex spontaneously decompose; (e) absorption of a photon that places at least one ligand of the complex in a localized ligand excited state; a bond between the excited ligand and the complex is unstable; the bond breaks, and the remaining parts of the complex spontaneously decompose; (f) absorption of a photon that places the complex in an intramolecular charge transfer excited state such that at least one ligand of the complex is unstable and decomposes, then the remaining parts of the complex are unstable and spontaneously decompose; (g) absorption of a photon that places at least one ligand of the complex in a localized ligand excited state, wherein the excited ligand is unstable and decomposes, then the remaining parts of the complex are unstable and spontaneously decompose; and (h) absorption of a photon that places the complex in a metal-to-ligand charge transfer excited state in which at least one ligand of the complex is unstable and decomposes, then the remaining parts of the complex are unstable and spontaneously decompose. In its broad aspects, however, this invention is not to be construed to be limited to these reaction mechanisms.

Completion of conversion of the precursor material may be the last step in certain embodiments. In other embodiments, no post-exposure treatment of the exposed precursor material is required, but further patterning may be desirable. Alternatively, however, in certain embodiments an optional post-conversion processing step may be required, and the process proceeds to step 106.

In step 106 of FIG. 1, following at least partial conversion of the deposited precursor, the precursor film may optionally be treated by any of a variety of prior art methods before removing at least a portion of the unconverted precursor layer. These methods include, but are not limited to, annealing treatments, e.g. thermal, laser or plasma annealing steps; exposure to a specific atmosphere, e.g., oxidizing or reducing; ion implantation; microwave treatment and electron beam treatment. If the at least partially converted area(s) serve as electroless plating nucleation sites relative to the unconverted area(s) of the precursor, then an optional plating step may be used at this stage. If the film is a blanket film, and no further patterning or treatment is necessary, the film deposition process is terminated at this point.

In step 107 of FIG. 1, following exposure and/or post-exposure treatment, unexposed regions of the deposited film, or a portion thereof, may be removed by the application of a film-removing agent. For example, a film-removing agent may comprise a developer composition that may be applied as a liquid or a solution in a puddle development or immersion wet development process. Alternately, a dry development process, analogous to dry patterning steps conventionally employed by the semiconductor industry, may be employed as a film-removing agent. Preferred film removal methods include spray development, puddle development, and immersion wet development.

The developer should be formulated and/or used under conditions such that a solubility difference exists between exposed and unexposed regions of the film. This solubility difference is used to preferentially remove select regions of the film such that certain regions of the film are substantially removed by the developer while other regions are left substantially intact. For example, in a process in which regions exposed to incident energy are desired to remain on the substrate, use of the casting solvent to develop the film after exposure to incident radiation may be too aggressive. A dilute solution of the casting solvent in another liquid in which (a) the casting solvent is miscible, (b) unexposed regions of the film are sparingly (but not necessarily completely) soluble, and (c) exposed regions of the film are substantially insoluble, provides for an improved development process.

To further illustrate, in one preferred embodiment of the invention an amorphous film may be cast from a ketone solution. However, in contrast, the development process is more effective using alcohol as the majority component, versus using ketone alone as a developer, or a ketone-rich mixture of alcohol and the ketone, i.e., a mixture with greater than 50 vol. % ketone. For instance, 10:1 (vol/vol) isopropanol (IPA): methyl isobutyl ketone (MIBK) solution is a more effective developer for BaₓSr_{y}Ti_{z}O₃ (“BST”) than MIBK alone or 1:1 (vol/vol) IPA:MIBK. The 20:1 mixture, in turn, is more effective than 10:1 IPA:MIBK. However, both of the 10:1 and 20:1 solutions are more effective than a solution of 40:1 (vol/vol) IPA:MIBK. Furthermore, the relative effectiveness of these solutions depends heavily on other processes employed in the formation of the patterned film including, for example, the type and energy of incident radiation and the temperature of the substrate during coating and patterning. Liquid and/or solution-based developers may be physically applied in a fashion analogous to development methods employed with photoresist-based processes, for example, those discussed above. For many embodiments, no further processing is necessary following this step 107.

In step 108 of FIG. 1, however, optional treatment of the patterned film following development may be desirable. For example, at this step any amorphous film formed may be converted to polycrystalline or crystalline films, e.g., by the application of elevated temperatures or various other nucleation processes, such as photo-induced nucleation. After development, the at least partially converted precursor may, optionally, be treated by any of a variety of methods well known to the art prior to its being subjected to further converting means. These methods include, but are not limited to, annealing treatments, such as thermal, laser or plasma annealing. The temperature and time of such annealing are important variables. The annealing step may also be influenced by prior surface treatments, for example, oxygen plasma, laser or a rapid thermal annealing (“RTA”) process. It is possible to select appropriate conditions such that the annealed at least partially converted precursor retains its amorphous nature while at least one of its physical or electrical properties is desirably altered. Alternatively, annealing conditions that cause the film to convert to its crystalline state, e.g., a high temperature anneal, may be desirable depending on the application for which the film is to be used. For example, appropriate thermal treatment at this stage may be employed to induce the formation of highly oriented crystalline films from the amorphous, or at least substantially amorphous, at least partially converted precursor. In this manner, the properties of the amorphous film may be finely tuned, or its physical properties may even be varied over a wide range—from the completely amorphous phase at one extreme to semi-crystalline intermediate phases to a single oriented crystalline phase at the other extreme. Such thermal treatment will usually act to further convert the precursor.

If the precursor has yet to be substantially fully converted, the precursor film is next optionally subjected to an energy source such that the precursor is substantially fully converted. The entire film or selected regions of the precursor film may be exposed to a source of energy. The energy source can be an energy source that is the same or different from any energy source previously employed. For example, the energy source may be a light source of a specific wavelength, a coherent light source of a specific wavelength, a broadband light source, an electron beam source, and/or an ion beam source. In certain embodiments of the invention, the energy source, or at least a portion of the energy source, is a light source directed through an optical mask used to define an image on the surface, as discussed above. However, the energy source need not be directed through a mask. For example, it may not be necessary to pattern the material during this conversion step because, e.g., the precursor may already be patterned. Therefore, a flood or blanket exposure may be used as the converting means. Preferred energy sources include light, electron beam, ion beam, and thermal treatment. As discussed above for the case of partial conversion, and as is also applicable here, the atmospheric conditions under which the deposited film is converted, such as atmosphere composition, pressure, both total and partial, and humidity, may be important process variables. During conversion, these variables may be the same as or different from their settings used in any preceding partial conversion step.

It is recognized that some shrinkage of the film may occur during the process of partially converting and/or substantially fully converting the precursor film to the film of the desired material. Therefore, the thickness of the film of the desired material is often less than the thickness of the unconverted precursor film. This change in thickness is an important feature of the invention, conferring useful properties to the film of desired material. For example, formation of extremely thin films is advantageous with respect to maximizing capacitance, while at the same time the formation of such thin films is challenging from a manufacturing standpoint. Therefore, the process of the invention provides not only the capability to apply relatively thicker cast films, thus conferring greater manufacturing ease, but also provides relatively thinner films of the desired at least partially converted precursor material, thereby conferring improved properties to the film of the desired material. The shrinkage properties of the deposited film may be controlled and tuned to target parameters by judicious manipulation of many of the aforementioned process variables including: the selection of the precursor, the selection and quantity of the solvent, the identity of precursor additives, the thickness of the precursor film as determined by the deposition process, the use of thermal treatments before, during and after the patterning of the film, and the development of the exposed film. The process of the invention allows for precise thickness control of desired films ranging in total thickness from the Angstrom range through the micrometer range.

After conversion through light exposure 105, subsequent optional process steps may include post-conversion treatment 106, developing 107, including but not limited to the novel development method discussed above, and post-developing treatment steps 108. However, other novel methods of metal film formation are recognized outside of the framework outlined in FIG. 1. For example, it is also possible to combine heating with photodeposition through the following process. The precursor film is first deposited on a substrate using any of the deposition techniques described above. The film is then exposed to a light source and photopatterned, as is discussed in step 105 above, resulting in a converted, patterned film. This substrate containing the photopatterning is then heated to 35° C. for 3 minutes in air, oxygen, or some other oxidizing environment, as before. This results in a layer containing photopatterned lines, comprised substantially of silver, as well as by areas surrounding the photopatterned lines, comprised primarily of silver oxide. The areas comprised of silver oxide are regions unconverted by exposure to light. The nature of the resulting film may be modified through manipulation of experimental conditions. Depending on the time, temperature or gas pressures used during the heating step, for example, there may be some oxidation of the silver photopatterned film, as well as of the area that was not photopatterned. In this way, for instance, it may be possible to create a thicker film than is normally possible through the photolytic deposition process.

These variables are intended as examples and are not to be considered exhaustive lists of the variables that may be manipulated to affect the properties of the resulting film. More specific aspects and embodiments of the present invention are described in detail below.

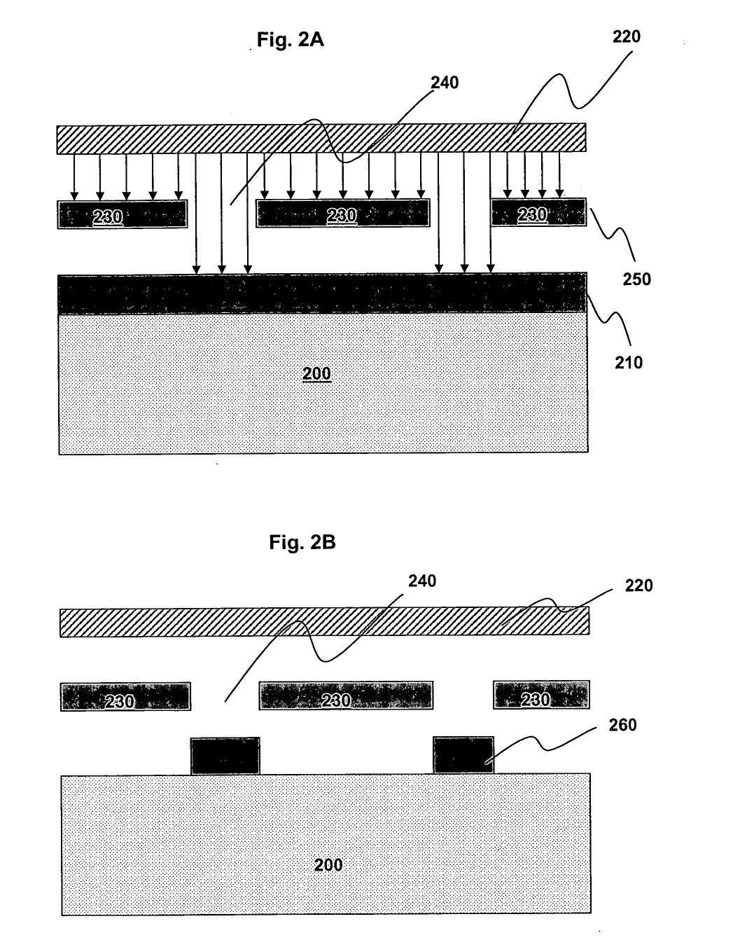

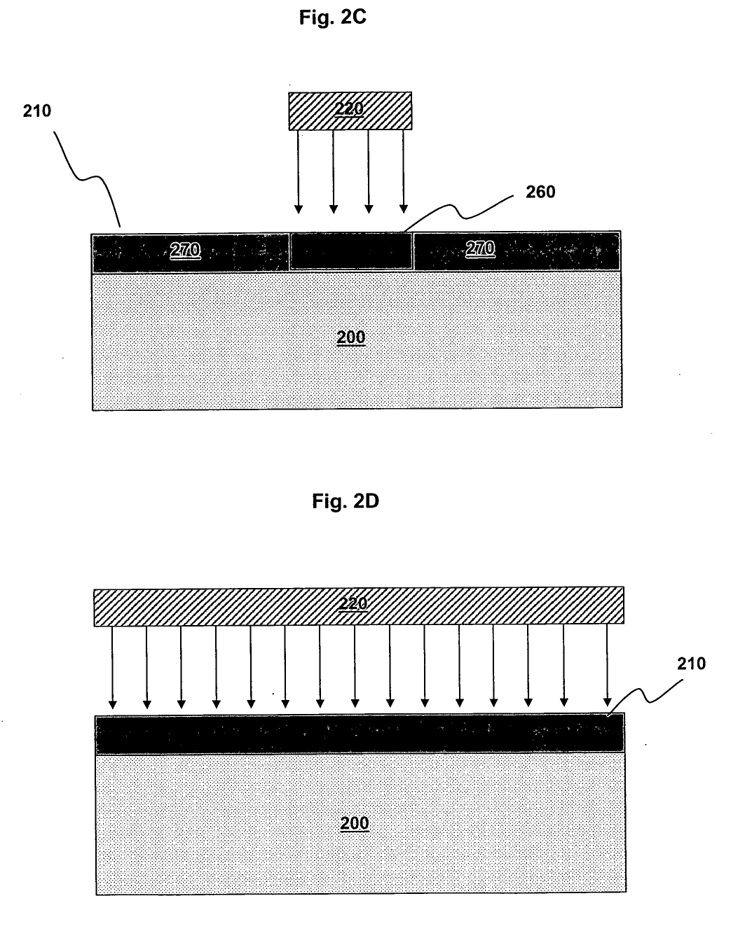

FIGS. 2A and B are schematic cross-sectional views of a substrate covered with precursor material and exposed to an energy source that will convert the precursor material. Turning briefly to FIG. 2A, in certain embodiments of the invention, the energy source is a light source 220 directed through an optical mask 250 used to define an image on the surface of the precursor material 210. The mask 250 consists of substantially transparent regions 240 and substantially opaque or light absorbing 230 regions. The mask 250 may also include an optical enhancing feature such as a phase shift technology (not shown). FIG. 2B illustrates that, following conversion of the precursor material 210, the non-converted precursor material may be removed. This leaves a patterned film of converted precursor material 260.

However, the energy source need not be directed through a mask. In another embodiment, shown in FIG. 2C, a patterned film 260 may be formed directly. In this embodiment, a layer of precursor material 210 is deposited on a substrate 200. Following (optional) post-deposition treatment, the unconverted precursor material is irradiated using an energy source 220. However, rather than using a mask to form a pattern on the precursor material, the energy source forms a patterned film 260 directly in the precursor material. Certain light sources 220, such as x-ray or laser, for example, may be able to directly pattern the image onto the surface through a steering mechanism (not shown), for instance. Once the pattern 260 is formed, unconverted precursor material 270 may be removed.

Finally, FIG. 2D illustrates that, while the above embodiments may be preferred, it should be understood that the current invention is not limited to converting precursor materials to form patterned films. If it is not necessary to pattern the precursor material 210, a flood or blanket energy exposure 220 may be used. Such an exposure will result in the formation of an unpatterned, blanket film (not shown).

In a variation of the above embodiments, the atmosphere and pressure, both total and partial, under which the deposited film is at least partially converted through exposure to an energy source may be important process variables. Normally, it is convenient and economical for the atmosphere to be air, but it may be preferable to change the composition of the atmosphere present during at least partial conversion. One reason for this is to increase the transmission of the exposing light, if short wavelength light is used, because such light may be attenuated by air. Another reason to change the composition of the atmosphere may be to alter the composition or properties of the product film. For example, the exposure of a copper complex results in the formation of a copper oxide in air or oxygen atmospheres. By virtually eliminating oxygen from the atmosphere, a film comprising primarily reduced copper species may be formed. In another example, a partial conversion or conversion step is preferably performed in the presence of oxygen, if the converted precursor is to be a dielectric film, or in the presence of a reducing gas, such as hydrogen, if the converted precursor is to be a metallic film. Additionally and optionally, the amount of oxygen in the film may be further altered by modifying the humidity of the atmosphere in which conversion takes place.

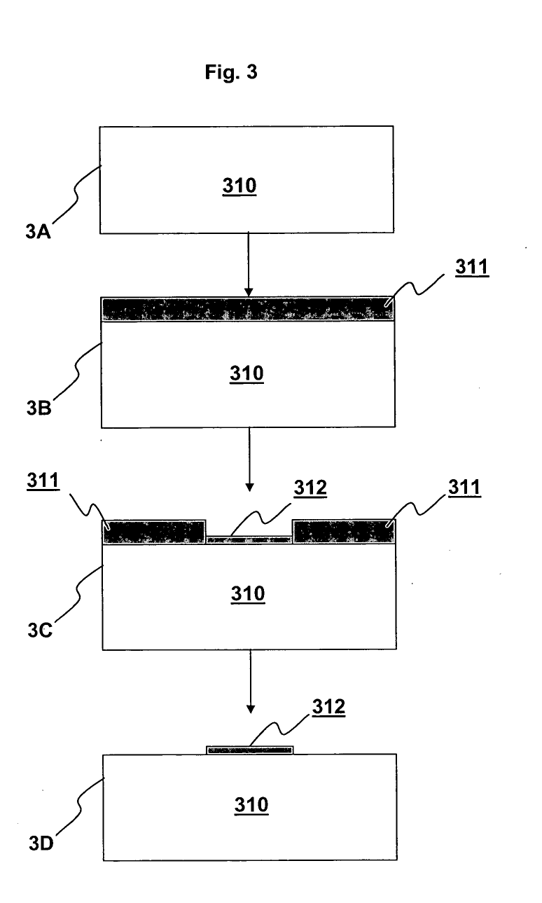

FIG. 3 illustrates deposition of a patterned film through a process according to one embodiment of the present invention. FIG. 3 illustrates the basic sequence of steps for a preferred embodiment of the process of the present invention conducted on a substrate 310. The substrate 310 may be, for example, a silicon wafer that has been coated with an organic layer. In step 3B, unconverted precursor 311 is applied to the substrate 310. In step 3C, an energy source, such as light in the photochemical metal organic deposition process, or thermal or heat treatment, is applied to at least one selected portion of unconverted precursor 311 to form a converted precursor layer 312. In step 3D, a film-removing agent, such as a developer composition, is used to remove at least a portion and, preferably, substantially all, of the unconverted precursor layer 311, leaving the converted precursor 312 intact, thereby forming a patterned metal film on the substrate 310.

Alternately, in step 3C of FIG. 3, an energy source, such as light or thermal or heat treatment, may be applied to at least one selected portion of unconverted precursor 311 to form a partially converted precursor layer 312. In step 3D, a film-removing agent, such as a developer composition, is used to remove at least a portion and, preferably, substantially all, of the unconverted precursor layer 311, leaving the partially converted precursor 312 intact. An energy source, not shown, such as light or thermal or heat treatment, can then be used on at least a portion of the partially converted precursor to substantially convert that portion, thereby forming a patterned film. The energy source used to partially convert the precursor layer can be the same as or different from the energy source used to substantially convert the film. FIG. 3 demonstrates the economy of steps in forming a patterned film by the process of the present invention.

The following examples further illustrate certain embodiments of the present invention. These examples are provided solely for illustrative purposes and in no way limit the scope of the present invention.

### EXAMPLE 1

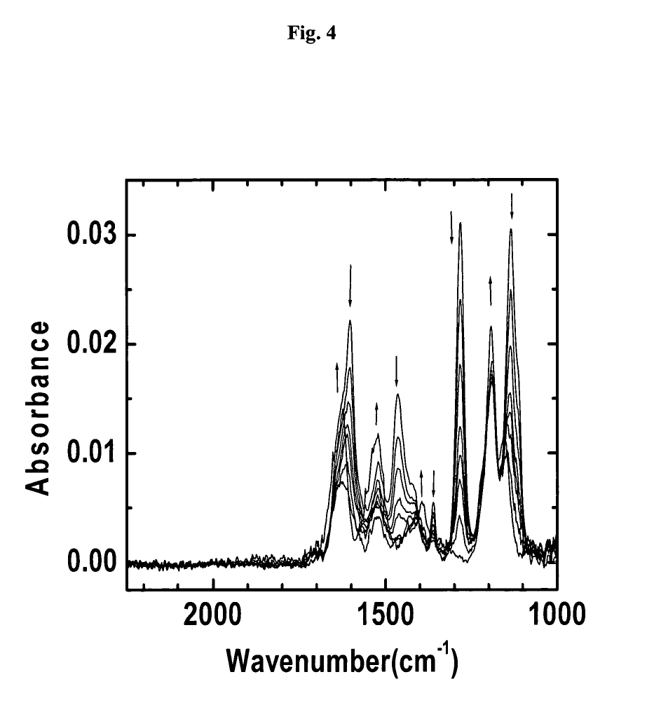

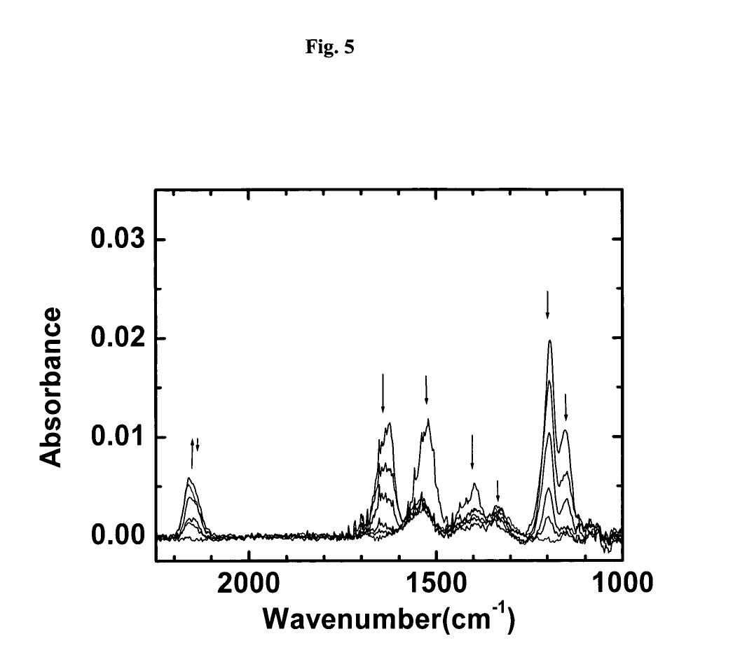

Photolytically-deposited films directly deposit silver metal, without using post-deposition treatment. In a preferred embodiment, thin amorphous films of silver trifluoroacetylacetonate were deposited on calcium fluoride using the using the spin coating technique (using a solution made from silver trifluoroacetylacetonate (0.063 g), 1 butanol (0.20 mL) and ethanol (1.4 g)). The Fourier Transform Infrared spectroscopy (FTIR) spectrum of the film was recorded. The resulting precursor film was then photolysed with the output from a low-pressure mercury lamp. The progress of the reaction was monitored using FTIR, measuring the absorption bands in the region from 2000-1000 cm⁻¹ associated with the vibrations of the ligand. The first stage of photolysis, covering a period of 32 minutes, is shown in FIG. 4. The photolytic reaction times shown correspond to 0, 1, 2, 4, 6, 10, 16, and 32 minutes. During the first stage of photolysis, major peaks associated with the ligand, at 1603, 1464, 1360, 1280, and 1134 cm⁻¹, decreased in intensity. There was a concomitant increase in intensity in peaks at 1624, 1522, 1395, and 1192 cm⁻¹ during the first stage of photolysis. Photolysis then continued for a total of 288 minutes. During this “second stage” of photolysis, the absorption bands that had initially increased in intensity during the first stage of photolysis were observed to decrease in intensity. FIG. 5 shows FTIR spectra taken at 32, 96, 122, 170, 244, and 288 minutes of accumulated photolysis time. While the inventor does not wish to be bound by any one theory as to what was observed during photolysis, the explanation is thought to be as follows.

During the second-stage of the photolytic reaction, there may be two different reaction processes occurring. First, during the period from 28 to 80 minutes, the peaks at 1522 and 1395 cm⁻¹ largely disappear. Following the disappearance of these peaks, the remaining peaks are lost, at 1624 and 1192 cm⁻¹, in the interval between 80 and 288 minutes. During this phase of the decomposition process, a single absorption band grows in at about 2140 cm⁻¹. This peak is presumably associated with CO, which is formed as a result of ligand decomposition. The absorbance associated with CO peaks at about 224 minutes, and decreases slightly in intensity by 288 minutes. This suggests that decomposition of oxygen-containing ligands in the film is largely complete by about 244 minutes, and the decrease in absorption is associated with diffusion of CO from the film. This interpretation of the mechanism is further buttressed by the observation that the CO feature disappears entirely when the photolysed film is left to stand for a prolonged period.

A similar sample was deposited on an oxidized silicon (111) surface, and the FTIR spectrum was measured over a similar time period. The spectral changes were found to be in accord with the above example, although the signal to noise of the measurement was somewhat worse due to lower transmission of the spectral beam through silicon.

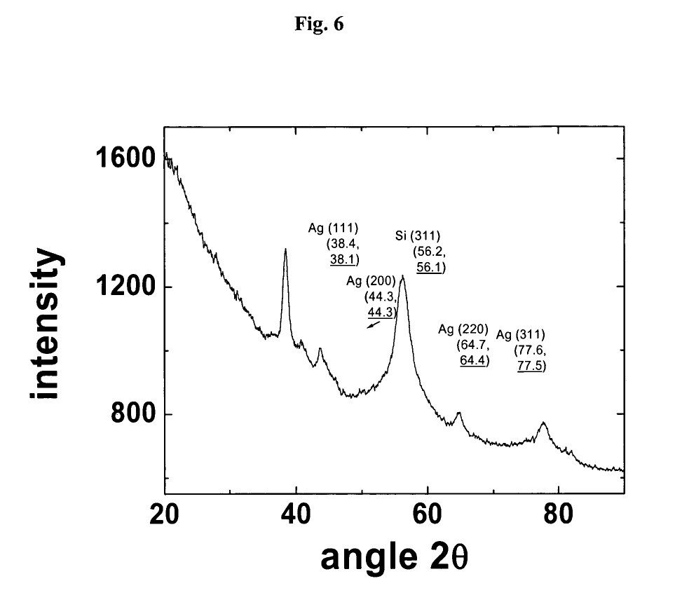

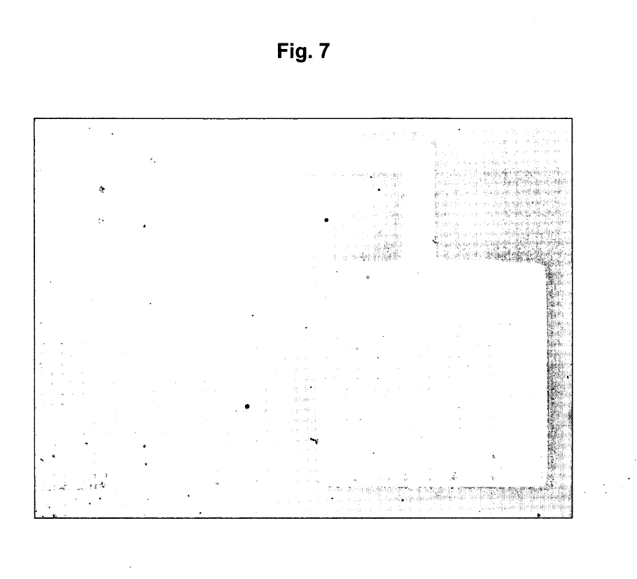

The samples deposited on calcium fluoride were then characterized using x-ray diffraction (XRD) (FIG. 6). The instrument used for the measurement was a Rigaku R-AXIS Rapid-S diffractometer equipped with a Rigaku 2000 x-ray generator. The diffraction pattern showed strong reflections at 2θ values of 38.4, 44.3, 56.0, 64.7, and 77.6 degrees. The majority of these reflections can be assigned to the 111, 200, 220, and 311 reflection of silver. Literature values of these reflections are 38.1, 44.3, 64.4, and 77.5 degrees, respectively. The anomalous peak at 56.0 degrees may be associated with the substrate, and is presumably due to the silicon 311 reflection.

The Auger electron (AES) spectrum of the sample was next obtained. Following sputtering of the surface to remove contamination, the only peaks visible were associated with silver (93%) and oxygen (7%).

Finally, the conductivity of the film was measured. The as-deposited sample was too thin to measure reliably, so a similar sample was made by sequentially depositing three layers of silver. The sheet resistance of this sample was 0.083 ohm/square.

### EXAMPLE 2

An experiment similar to Example 1 was performed, except under a nitrogen atmosphere instead of in air. The x-ray diffraction data indicated the formation of metallic silver, while the Auger analysis showed 91% silver and 9% oxygen. The observed oxygen is thought to be an artifact, resulting from exposing the sample to air while transferring to the Auger spectrometer. The measured conductivity of the sample prepared under nitrogen, after exposure to air, did not differ significantly from that of the sample prepared in air.

More generally, the deposition atmosphere may be modified to impart specific properties to silver films deposited according to the present invention. A variation of the current embodiment involves changing the humidity of the gas used in the controlled environment as a method of modifying the resultant film. In this variation, the amount of humidity in the gas is controlled (or alternatively, eliminated) as a method of selectively controlling the amount of oxygen introduced. This technique may be used with any of the disclosed gaseous atmospheres as a method of controlling the deposition and/or compositional gradient of oxides in metal oxide films.

In yet another variation of the current embodiment, the nature of the atmosphere may also be used to influence the reaction rate when using the thermal decomposition method of film formation. Following deposition of the precursor film using the spin coating from ethanol technique, the film is heated in air while following reaction progress via FTIR. The measured half-life (defined as the length of time required for the reaction to proceed approximately one-half of the way to completion) is approximately six minutes. An identical experiment performed in a nitrogen atmosphere has a half-life of approximately 180 minutes.

### EXAMPLE 3

To illustrate a negative lithographic process using the present invention, 0.1136 g silver (I) trifluoroacetylacetonate was dissolved in 1.0059 g of anhydrous ethanol, forming a precursor solution. A thin film was spin-coated on a silicon substrate from the precursor solution. Immediately following spin coating, the film appeared sky blue. After coating, the thin film was irradiated using 254 nm UV light through a photomask inscribed with the shape of the number 30. The sample was irradiated for a total of 192 minutes. Following irradiation, the appearance of the spin-coated substrate changed. The area of the substrate exposed to the 254 mn radiation through the photomask appeared silver in color, and was in the shape of the number 30. The remainder of the sample, which was not irradiated by UV light, remained sky blue in color. The pattern created by exposure to UV light is shown in FIG. 7.

Following irradiation, the sample was rinsed in ethanol for 30 seconds, then removed from the solution and dried using clean dry air. The area of the substrate exposed to UV irradiation through the photomask remained silver in color. The area of the substrate unexposed to UV irradiation changed from the as-deposited sky-blue color to the shiny greyish color of silicon. The change in color indicated that there was substantial removal of the unexposed precursor material following development using ethanol. The silver-colored converted precursor material remaining on the silicon substrate following irradiation and development formed the shape of the number 30, illustrating successful negative lithographic transfer of the hardmask pattern to the substrate.

Although the present invention has been described with particular reference to its preferred embodiments, it should be understood that these embodiments are illustrative and that the invention may be modified and practiced in different but equivalent manners apparent to those skilled in the art having the benefit of the teachings herein. It is therefore evident that the particular embodiments disclosed above may be altered or modified in ways that such variations are considered within the scope and spirit of the invention. Therefore, the scope of the invention should not be limited by the specific disclosure herein, but only by the appended claims.

What is claimed is:

1. A method for producing a film of silver-containing material on a substrate, comprising:
depositing an amorphous film comprising at least one silver-containing precursor material on a surface of a substrate; and
irradiating the amorphous film to produce an irradiated film comprising elemental silver.

2. The method of claim 1 wherein the elemental silver film is substantially conductive.

3. The method of claim 1 wherein the irradiated film further comprises silver oxide.

4. The method of claim 3 wherein the silver oxide film is substantially a semiconductor.

5. The method of claim 1 wherein the irradiating comprises irradiating the film with electromagnetic radiation.

6. The method of claim 1 wherein the irradiating comprises irradiating the film with ultraviolet light.

7. The method of claim 1 wherein the irradiating comprises irradiating the film with laser light.

8. The method of claim 1 wherein the irradiating causes a substantially thermal reaction in the film.

9. The method of claim 1 wherein the irradiating comprises photolysis.

10. The method of claim 1 wherein the irradiating comprises irradiating the film with visible light.

11. The method of claim 1 wherein the irradiating comprises irradiating the film with an ion beam.

12. The method of claim 1 wherein the irradiating comprises irradiating the film with an electron beam.

13. The method of claim 1 further comprising reducing the elemental silver and silver oxide after irradiating.

14. The method of claim 1 wherein the irradiating is done in a controlled atmosphere.

15. The method of claim 13 wherein the controlled atmosphere comprises nitrogen.

16. The method of claim 13 wherein the controlled atmosphere comprises a vacuum.

17. The method of claim 13 wherein the controlled atmosphere comprises air.

18. The method of claim 16 wherein the controlled atmosphere further comprises water.

19. The method of claim 1 further comprising removing remaining unirradiated silver-containing precursor material from the substrate.

20. The method of claim 1 wherein the silver-containing precursor comprises silver complexed with at least one ligand, said ligand comprising: 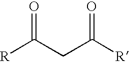
wherein R and R′ are each independently selected from CₙHₘ and CₙHₘAₓB_{y}, wherein n, m, x and y are integers, and wherein A and B each independently comprise in-chain, terminal or pendant functional groups.

21. The method of claim 1 wherein the silver-containing precursor comprises silver (I) hexafluoroacetate tetraglyme.

22. The method of claim 1 wherein the silver-containing precursor comprises silver (I) trifluoroacetylacetonate.

23. The method of claim 1 wherein the silver-containing precursor comprises silver hexafluoroacetylacetonate.

24. The method of claim 1 wherein the silver-containing precursor comprises silveracetylacetonate.

25. The method of claim 1 further comprising covering the amorphous film with a mask that leaves a patterned area exposed.

26. A method for making a pattern of a silver-containing precursor on a substrate, comprising:
depositing an amorphous film comprising a silver-containing precursor on a surface of a substrate; and
irradiating the amorphous film using a patterning means to produce a patterned irradiated film comprising elemental silver and silver oxide.

27. The method of claim 25 wherein the silver-containing precursor material is selected from the group consisting of silver (I) hexafluoroacetate tetraglyme, silver (I) trifluoroacetylacetonate, silver hexafluoroacetylacetonate, silveracetylacetonate, and combinations thereof.

28. The method of claim 25 wherein unirradiated silver complex is subjected to heating, the heating converting the unirradiated silver complex into a film comprising silver oxide.

29. The method of claims 1 or 25, wherein the elemental silver and silver oxide film is heated in an atmosphere comprising hydrogen.

30. The method of claim 25 further comprising removing unirradiated silver-containing precursor after irradiating.
